(19) United States
(12) Patent Application Publication
(10) Pub. No.: US 2012/0089790 A1
(43) Pub. Date: Apr. 12, 2012

(54) STORAGE DEVICE AND METHOD FOR ACCESSING DATA USING THE SAME

(75) Inventor: YING-CHUAN TSAI, Tu-Cheng (TW)

(73) Assignee: HON HAI PRECISION INDUSTRY CO., LTD., Tu-Cheng (TW)

(21) Appl. No.: 13/108,992

(22) Filed: May 17, 2011

(30) Foreign Application Priority Data
Oct. 7, 2010 (TW) 99134201

(51) Int. Cl. G06F 12/00

(52) U.S. Cl. 711/154; 711/E12.001

(57) ABSTRACT

A method for accessing data using a storage device determines if a data writing request is received from a first data processing device by a first interface of the storage device, and stores a document corresponding to the data writing request into a storage area of the storage device when the data writing request is received by the first interface.

The method further determines if a data reading request is received from a second data processing device by a second interface of the storage device, reads the document from the storage area of the storage device according to the data reading request when the data reading request is received by the second interface, and sends the document to the second data processing device.

### BACKGROUND

1. Technical Field

Embodiments of the present disclosure relate to data access technology, and particularly to a storage device and method for accessing data using the storage device.

2. Description of Related Art

Portable storage devices, such as universal serial bus (USB) devices, can be used to transmit data between two electronic devices. In order to transmit data from one electronic device to another electronic device, the portable storage device first needs to be connected to the first electronic device, and the relevant data must be copied to the portable storage device. Then, the portable storage device must be connected to the second electronic device so the data can be copied again to the second electronic device. It is inconvenient and inefficient for the user to access data between different electronic devices. Therefore, an improved storage device and method for accessing data is desired.

### BRIEF DESCRIPTION OF THE DRAWINGS

FIG. 1 is a block diagram of one embodiment of a storage device.

FIG. 2 is a block diagram of one embodiment of a data accessing system in the storage device.

FIG. 3 is a flowchart of one embodiment of a method for accessing data using the storage device.

### DETAILED DESCRIPTION

All of the processes described below may be embodied in, and fully automated via, functional code modules executed by one or more general purpose electronic devices or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

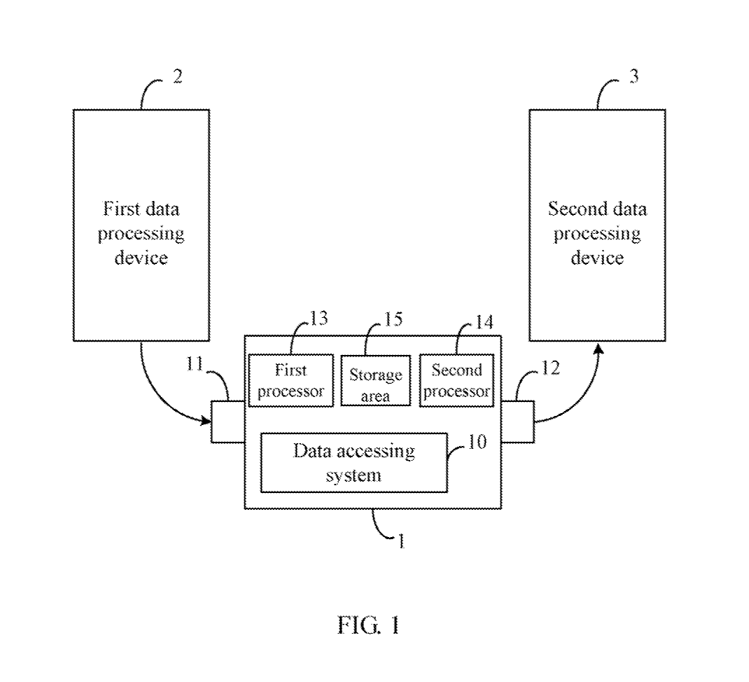

FIG. 1 is a block diagram of one embodiment of a storage device 1. The storage device 1 includes a data accessing system 10, a first interface 11, a second interface 12, a first processor 13, a second processor 14, and a storage area 15. The first processor 13 is connected to the first interface 11, the second processor 14 is connected to the second interface 14, and the storage area 15 is connected to the first processor 13 and the second processor 14. In one embodiment, the first interface 11 is connected to a first data processing device 2, and the second interface 12 is connected to a second data processing device 3. For example, the first interface 11 or the second interface 12 may be a universal serial bus (USB) port of the storage device 1.

The data accessing system 10 may be used to transmit data between the first data processing device 2 and the second data processing device 3 through the first interface 11 and the second interface 12. In one embodiment, the storage device 1 may be a USB device, the storage area 15 may be a non-volatile storage, such as a field replacement unit (FRU) storage area.

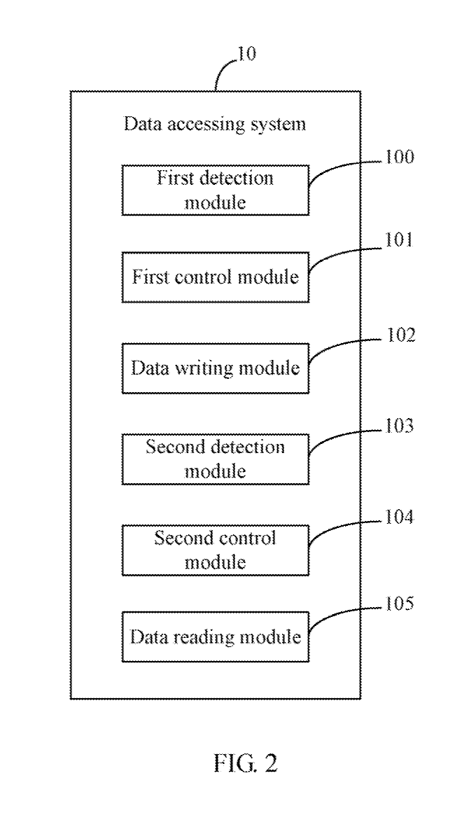

FIG. 2 is a block diagram of one embodiment of the data accessing system 10 in the storage device 1. In one embodiment, the data accessing system 10 may include one or more modules, for example, a first detection module 100, a first control module 101, a data writing module 102, a second detection module 103, a second control module 104, and a data reading module 105. The one or more modules 100-105 may comprise computerized code in the form of one or more programs that are stored in the storage area 15 (or memory). The computerized code includes instructions that are executed by the first processor 13 and/or the second processor 14 to provide functions for the one or more modules 100-105.

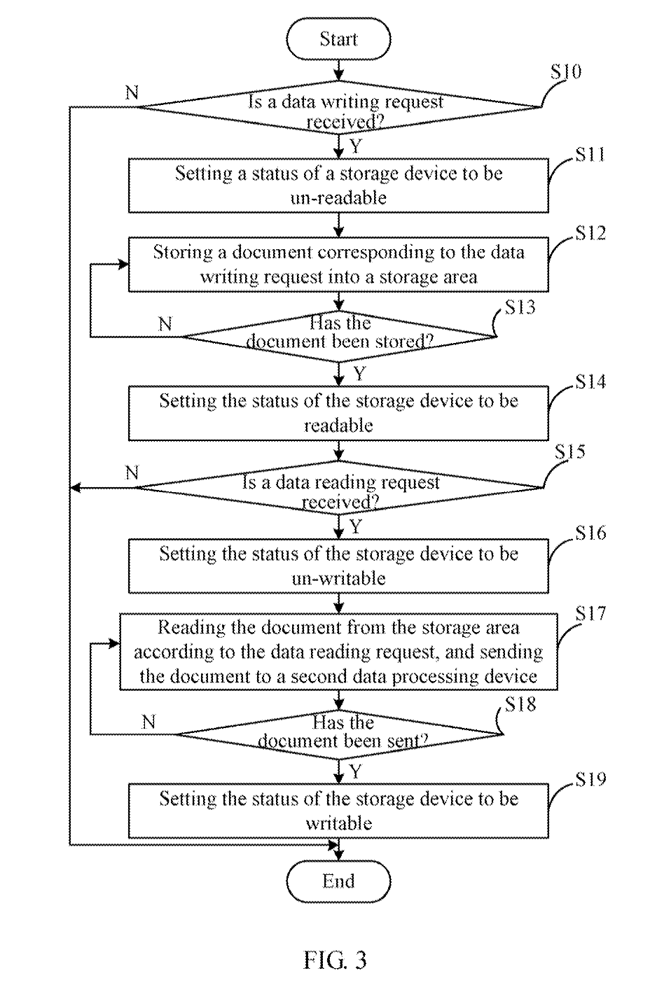

FIG. 3 is a flowchart of one embodiment of a method for accessing data using the storage device 1. Depending on the embodiment, additional blocks may be added, others removed, and the ordering of the blocks may be changed.

In block S10, the first detection module 100 determines if a data writing request is received from the first data processing device 2 by the first interface 11 of the storage device 1. If the first interface 11 receives the data writing request, the procedure goes to block S11. If the first interface 11 does not receive the data writing request, the procedure ends. In one embodiment, the data writing request includes, but is not limited to, a name of a document needed to transmit to the second data processing device 3, contents of the document, and a size of the document.

In block S11, the first control module 101 sets a status of the storage device 1 to be un-readable by setting a signal of the second processor 14 of the storage device 1 to be a high level. In one embodiment, the high level is defined as logic 1.

In block S12, the data writing module 102 stores the document corresponding to the data writing request into the storage area 15 of the storage device 1.

In block S13, the data writing module 102 determines if the document has been stored into the storage area 15. In one embodiment, if a size of the data stored into the storage area 15 equals the size of the document in the data writing request, the data writing module 102 determines that the document has been stored into the storage area 15, the procedure goes to block S14. If the size of the data stored into the storage area 15 is less than the size of the document in the data writing request, the data writing module 102 determines that the document has not been stored into the storage area 15, the procedure returns to block S12.

In block S14, the first control module 101 sets the status of the storage device 1 to be readable by setting the signal of the second processor 14 of the storage device 1 to be a low level. In one embodiment, the low level is defined as logic 0.

In block S15, the second detection module 103 determines if a data reading request is received from the second data processing device 3 by the second interface 12 of the storage device 1. If the second interface 12 receives the data reading request, the procedure goes to block S16. If the first interface 11 does not receive the data reading request, the procedure ends. In one embodiment, the data reading request includes, but is not limited to, the name of the document stored in the storage device 1.

In block S16, the second control module 104 sets the status of the storage device to be un-writable by setting a signal of the first processor 13 of the storage device 1 to be a high level.

In block S17, the data reading module 105 reads the document from the storage area 15 of the storage device 1 according to the data reading request, and sends the document to the second data processing device 3.

In block S18, the data reading module 105 determines if the document has been sent to the second data processing device 3. In one embodiment, if a size of the data sent to the second processing device 3 equals the size of the document stored in the storage area 15, the data reading module 105 determines that the document has been sent to the second data processing device 3, the procedure goes to block S19. If the size of the data sent to the second processing device 3 is less than the size of the document stored in the storage area 15, the data reading module 105 determines that the document has not been sent to the second data processing device 3, the procedure returns to block S17.

In block S19, the second control module 104 sets the status of the storage device 1 to be writable by setting the signal of the first processor 13 of the storage device 1 to be a low level.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for accessing data using a storage device, the storage device in communication with a first data processing device and a second data processing device, the method comprising:
determining if a data writing request for transmitting a document is received from the first data processing device by a first interface of the storage device;
storing the document corresponding to the data writing request into a storage area of the storage device upon the condition that the data writing request is received by the first interface of the storage device;
determining if a data reading request is received from the second data processing device by a second interface of the storage device; and
reading the document from the storage area of the storage device according to the data reading request upon the condition that the data reading request is received by the second interface of the storage device, and sending the document to the second data processing device.

2. The method according to claim 1, further comprising:
setting a status of the storage device to be un-readable by setting a signal of a second processor of the storage device to be a high level when the data writing request is received, the second processor being connected to the second interface.

3. The method according to claim 1, further comprising:
setting a status of the storage device to be readable by setting a signal of a second processor of the storage device to be a low level when the document has been stored in the storage area of the storage device, the second processor being connected to the second interface.

4. The method according to claim 1, further comprising:
setting a status of the storage device to be un-writable by setting a signal of a first processor of the storage device to be a high level when the data reading request is received, the first processor being connected to the first interface.

5. The method according to claim 1, further comprising:
setting a status of the storage device to be writable by setting a signal of a first processor of the storage device to be a low level when the document has been sent to the second data processing device, the first processor being connected to the first interface.

6. A storage device, comprising:
a storage area;
a first processor;
a second processor;
a first interface connected to the first processor and a second interface connected to the second processor; and
one or more modules that are stored in the storage device and are executed by the first processor and/or the second processor, the one or more modules comprising instructions:
to determine if a data writing request for transmitting a document is received from the first data processing device by the first interface of the storage device;
to store the document corresponding to the data writing request into a storage area of the storage device upon the condition that the data writing request is received by the first interface of the storage device;
to determine if a data reading request is received from the second data processing device by the second interface of the storage device; and
to read the document from the storage area of the storage device according to the data reading request upon the condition that the data reading request is received by the second interface of the storage device, and send the document to the second data processing device.

7. The storage device according to claim 6, wherein the one or more modules further comprise instructions: setting a status of the storage device to be un-readable by setting a signal of a second processor of the storage device to be a high level when the data writing request is received.

8. The storage device according to claim 6, wherein the one or more modules further comprise instructions: setting a status of the storage device to be readable by setting a signal of a second processor of the storage device to be a low level when the document has been stored in the storage area of the storage device.

9. The storage device according to claim 6, wherein the one or more modules further comprise instructions: setting a status of the storage device to be un-writable by setting a signal of a first processor of the storage device to be a high level when the data reading request is received.

10. The storage device according to claim 6, wherein the one or more modules further comprise instructions: setting a status of the storage device to be writable by setting a signal of a first processor of the storage device to be a low level when the document has been sent to the second data processing device.

11. A non-transitory storage medium having stored thereon instructions that, when executed by a first processor and a second processor of a storage device, causes the first processor and the second processor to perform a method for accessing data using a storage device, the storage device in communication with a first data processing device and a second data processing device, the method comprising:
determining if a data writing request for transmitting a document is received from the first data processing device by a first interface of the storage device;
storing the document corresponding to the data writing request into a storage area of the storage device upon the condition that the data writing request is received by the first interface of the storage device;
determining if a data reading request is received from the second data processing device by a second interface of the storage device; and
reading the document from the storage area of the storage device according to the data reading request upon the condition that the data reading request is received by the second interface of the storage device, and sending the document to the second data processing device.

12. The non-transitory storage medium according to claim 11, wherein the method further comprises: setting a status of the storage device to be un-readable by setting a signal of a second processor of the storage device to be a high level when the data writing request is received, the second processor being connected to the second interface.

13. The non-transitory storage medium according to claim 11, wherein the method further comprises: setting a status of the storage device to be readable by setting a signal of a second processor of the storage device to be a low level when the document has been stored in the storage area of the storage device, the second processor being connected to the second interface.

14. The non-transitory storage medium according to claim 11, wherein the method further comprises: setting a status of the storage device to be un-writable by setting a signal of a first processor of the storage device to be a high level when the data reading request is received, the first processor being connected to the first interface.

15. The non-transitory storage medium according to claim 11, wherein the method further comprises: setting a status of the storage device to be writable by setting a signal of a first processor of the storage device to be a low level when the document has been sent to the second data processing device, the first processor being connected to the first interface.

16. The non-transitory storage medium according to claim 11, wherein the medium is selected from the group consisting of a hard disk drive, a compact disc, a digital video disc, and a tape drive.
